(19) United States
(12) Patent Application Publication
(10) Pub. No.: US 2025/0178417 A1
(43) Pub. Date: Jun. 5, 2025

(54) Golf Cart Structural Partial Door

(71) Applicant: Charles Elam, Raymond, MS (US)

(72) Inventor: Charles Elam, Raymond, MS (US)

(21) Appl. No.: 18/635,068

(22) Filed: Apr. 15, 2024

Related U.S. Application Data
(60) Provisional application No. 63/604,315, filed on Nov. 30, 2023.

(51) Int. Cl. B60J 5/04; E05B 83/36

(52) U.S. Cl. CPC B60J 5/0487; B60J 5/048; E05B 83/36

(57) ABSTRACT

A novel metal/structural half or partial door apparatus for golf carts is disclosed. The apparatus consists of a planar member with a bolted end and a latched end and has a plurality of apertures along the bolted end for attachment via hinges to the golf cart frame. A handle and latch system facilitate easy access and secure closure of the door. The door is designed to cover up to 60% of the golf cart's height from the bottom of the golf cart. The door is designed to swing outwardly, enabling convenient access while offering side support (i.e., a side barrier) to passengers and safeguarding against the accidental ejection of occupants, pets, and items. The metal/structural half or partial door can be retrofitted onto existing golf carts or integrated during manufacturing and can be made from lightweight corrosion-resistant material or structural polymers.

### CROSS-REFERENCE TO RELATED APPLICATION

The present application claims priority to, and the benefit of, U.S. Provisional Application No. 63/604,315, which was filed on Nov. 30, 2023, and is incorporated herein by reference in its entirety.

### FIELD OF THE INVENTION

The present invention generally relates to the field of golf carts. More specifically, the present invention relates to a novel metal/structural half or partial door that can be designed to equip two- and four-seat golf carts. The door keeps passengers and items better secured within a cart while the cart is in motion, preventing the passengers and items from falling out of the cart. The door is preassembled and can be bolted onto the exterior of an existing golf cart. The door also provides adequate airflow while improving personal safety when riding in the cart. Accordingly, the present disclosure makes specific reference thereto. Nonetheless, it is to be appreciated that aspects of the present invention are also equally applicable to other like applications, devices, and methods of manufacture.

### BACKGROUND

By way of background, golf carts are often used on golf courses to transport golfers and their clubs around the course. Golf carts save time and reduce the physical strain on players, enabling them to conserve energy for the game. In retirement communities, golf carts are popular for personal transportation. Golf carts enable residents to visit amenities, socialize, and move around the community with ease. Universities and colleges use golf carts for multiple purposes, including campus security patrols and transporting staff and students. The small size and maneuverability of the golf carts make them ideal for navigating sprawling campuses efficiently. Golf carts have other uses such as golf carts are used in airports to transport passengers and staff, particularly those with disabilities or mobility issues, between terminals and gates.

The conventional golf carts have an open design along the sides and are without doors which enables for quick and easy access to the seats, facilitating swift boarding and disembarking. However, the absence of doors increases the risk of falling for young children and pets. Without a physical barrier of doors, there is also a greater chance of items and equipment being ejected from the vehicle and getting lost or damaged. As a result, the design of golf carts without doors poses safety concerns.

Conventional means such as seat belts for protection of passengers are ineffective and may not be used by children and pets. Individuals desire improved golf carts that provide airflow like open golf carts but also provide safety to passengers and items and prevent same from falling out during movement of the golf cart.

Therefore, there exists a long felt need in the art for golf cart doors that can be attached to existing golf carts or new golf carts. There is also a long felt need in the art for a metal/structural door that is preassembled and can be directly attached to a golf cart frame for providing safety to passengers and stored items. Additionally, there is a long felt need in the art for a golf cart door that provides adequate airflow while improving personal safety of passengers and items. There is also a long felt need in the art for a half or partial door that enables passengers to view outside and prevents individuals, pets, and objects from falling out. Further, there is a long felt need in the art for an improved golf cart that has half or partial doors attached on both sides. Furthermore, there is a long felt need in the art for a golf cart that has separate doors on each side which can be latched to improve personal safety when riding in the cart. Finally, there is a long felt need in the art for a metal/structural door that covers the lower half of a side of a golf cart to enable airflow and that offers a safe and secure way of keeping individuals, pets, items, tools, and any other objects contained within the golf cart.

The subject matter disclosed and claimed herein, in one embodiment thereof, comprises a golf cart metal/structural half or partial door. The metal/structural half or partial door is designed for attachment to at least one side of a golf cart to enhance passenger and item safety. The door apparatus includes a planar member which has a front surface and a rear surface, the planar member extends between a bolted end and a latched end, and a top end and a bottom end. A plurality of apertures is disposed along the bolted end for attachment to a golf cart frame using at least one hinge. A handle is disposed on the front surface and is linked to a latch system disposed on the rear surface. The metal/structural half or partial door has a height which is about 20% to 40% of the total golf cart height from base to top of the golf cart and is designed to enable airflow through the golf cart (between the top edge of the door and the golf cart) while preventing falling out of passengers, pets, and objects.

In this manner, the half metal/structural door of the present invention accomplishes all of the forgoing objectives and provides users with a metal/structural door that can be equipped to two-seat and four-seat golf carts. The metal/structural door can be attached to existing golf carts or new golf carts during manufacturing thereof. The metal/structural door maintains adequate airflow and improves personal safety of riders and stored items. The metal/structural door is designed based on the shape and size of the golf carts. The metal/structural door can be easily latched and swung outwardly for providing selective and secure access of the golf cart.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a golf cart metal/structural half or partial door apparatus designed for attachment to at least one side of a golf cart to enhance passenger and item safety. The door apparatus further comprises a planar member having a front surface and a rear surface, the planar member extends between a bolted end and a latched end, and a top end and a bottom end. A plurality of apertures is disposed along the bolted end for attachment to a golf cart frame using at least one hinge. A handle is disposed on the front surface and is linked to a latch system disposed on the rear surface. The metal/structural half or partial door is configured to enable airflow through the golf cart while preventing falling out of passengers, pets, and objects.

In another aspect, a golf cart metal/structural half or partial door apparatus is disclosed. The golf cart metal/structural half or partial door includes a planar member, the planar member extends between a bolted end and an opposite latched end, and a top edge and an opposite bottom edge. The height of the planar member extending between the top edge and the bottom edge is about 20% to 40% of the total golf cart height from base to top of the golf cart, the door apparatus further comprises a cart seat protection portion and a passenger leg room area protection portion, the portions form a contiguous, one-piece structure. A latch system is included that features a pawl connected to a ratchet, operatively connected to a striker for secure latching to the golf cart frame, wherein the door provides side support (i.e., a side barrier) to passengers and protects the leg room area and is adapted to swing outwardly from the golf cart for access of the golf cart.

In another embodiment, a metal/structural half or partial door system for a two-seat golf cart is disclosed. The door system includes a single metal/structural half or partial door on each side of the golf cart, each door is equipped with a handle and a latch system for easy opening and secure closing. The door system is designed to cover from 20% to 60% of the height of the golf cart for enhanced safety and airflow. The single metal/structural half or partial door includes a seat protection portion and a leg room area protection portion, wherein the door is capable of being retrofitted onto existing golf carts or integrated during the manufacturing process, made from lightweight corrosion-resistant metal or structural polymers that can be customized in design to match the golf cart.

In yet another embodiment, a golf cart equipped with a metal/structural half or partial door system is disclosed. The golf cart includes an integrated metal/structural half or partial door on each side of the golf cart, each metal/structural half or partial door comprises a front surface and a rear surface, a bolted or hinged end and a latched end extending between a top end and a bottom end, and a plurality of apertures along the bolted end for attachment to the golf cart frame. A handle is located on the front surface of each door and is connected to a latch system on the rear surface for enabling the door to swing outwardly from the golf cart. The metal/structural half or partial door is designed to enable airflow while preventing the egress of passengers, pets, and objects from the golf cart; and wherein the metal/structural half or partial doors include a cart seat protection portion and a passenger leg room area protection portion, providing side support (i.e., a side barrier) and protecting the leg room area respectively.

In still another embodiment, a metal/structural half or partial door for a golf cart and capable of transition between an open position and a closed position is disclosed. The metal/structural half or partial door includes a planar member bolted to a golf cart frame using at least one hinge, a latch system for latching the door to the golf cart frame, the door is departed or swung away from the golf cart in an outwardly motion by pulling a handle to transition the door in the open position and latching the door to the golf cart frame to transition the door in the closed position.

In yet another embodiment, a method for transitioning a metal/structural half or partial door of a golf cart between an open position and a closed position is disclosed. The method comprising the steps of providing a golf cart equipped with a metal/structural half or partial door on at least one side, where the metal/structural half or partial door includes a front surface, a rear surface, a bolted or hinged end, and a latched end extending between a top end and a bottom end; engaging a handle located on the front surface of the metal/structural half or partial door to initiate the door's outward swinging motion from the golf cart, thereby transitioning the door to an open position and enabling access to the interior of the golf cart; operating a latch system disposed on the rear surface of the metal/structural half or partial door, which includes a latch, a pawl connected to a ratchet, and a striker mechanism, wherein the pull tab is adapted to be pulled by a user to disengage the striker from a striker plate fastened to the golf cart frame, facilitating the door's movement; and releasing the pull tab to enable the striker to engage with the striker plate, thereby transitioning the metal/structural half or partial door to a closed position. The door aligns with the side of the golf cart and the latched end adheres to the golf cart frame in the closed position thereby forming a secure and contiguous structure that prevents unintentional disengagement and swinging of the door relative to the golf cart frame.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1A illustrates a front perspective view of the golf cart metal/structural half or partial door of the present invention in accordance with the disclosed architecture;

FIG. 1B illustrates a rear perspective view of the golf cart metal/structural half or partial door of the present invention in accordance with the disclosed architecture;

FIG. 2 illustrates a perspective view of the golf cart metal/structural half or partial door of the present invention equipped on a golf cart in accordance with one embodiment of the present invention;

FIG. 3 illustrates an enlarged view of the latch system used for latching the metal/structural half or partial door to the golf cart frame in accordance with one embodiment of the present invention;

FIG. 4 illustrates a perspective view of a four-seat golf cart equipped with metal/structural half or partial doors of the present invention in accordance with one embodiment of the present invention; and

FIG. 5 illustrates a perspective view of the four-seat golf cart equipped with metal/structural half or partial doors of the present invention with the doors in a closed position in accordance with one embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for golf cart doors that can be attached to existing golf carts or new golf carts. There is also a long felt need in the art for a metal/structural door that is preassembled and can be directly attached to a golf cart frame for providing safety to passengers and stored items. Additionally, there is a long felt need in the art for a golf cart door that provides adequate airflow while improving personal safety of passengers and items. There is also a long felt need in the art for a half or partial door that enables passengers to view outside and prevents individuals, pets, and objects from falling out. Further, there is a long felt need in the art for an improved golf cart that has half or partial doors attached on both sides. Furthermore, there is a long felt need in the art for a golf cart that has separate doors on each side which can be latched to improve personal safety when riding in the cart. Finally, there is a long felt need in the art for a metal/structural door that covers the lower half of a side of a golf cart to enable airflow and offers a safe and secure way of keeping individuals, pets, items, tools, and any other object contained within the golf cart.

The present invention, in one exemplary embodiment, a golf cart metal/structural half or partial door apparatus is disclosed. The golf cart metal/structural half or partial door includes a planar member, the planar member extends between a bolted end and an opposite latched end, and a top edge and an opposite bottom edge. The height of the planar member extending between the top edge and the bottom edge is about 20% to 60% of the total golf cart height from base to top of the golf cart, the door apparatus further comprises a cart seat protection portion and a passenger leg room area protection portion, the portions form a contiguous, one-piece structure. A latch system is included that features a pawl connected to a ratchet, operatively connected to a striker for secure latching to the golf cart frame, wherein the door provides side support (i.e., a side barrier) to passengers and protects the leg room area and is adapted to swing outwardly from the golf cart for access of the golf cart.

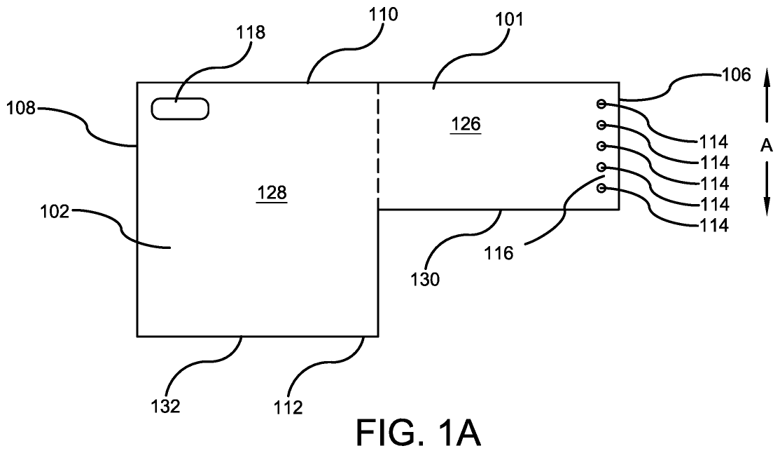

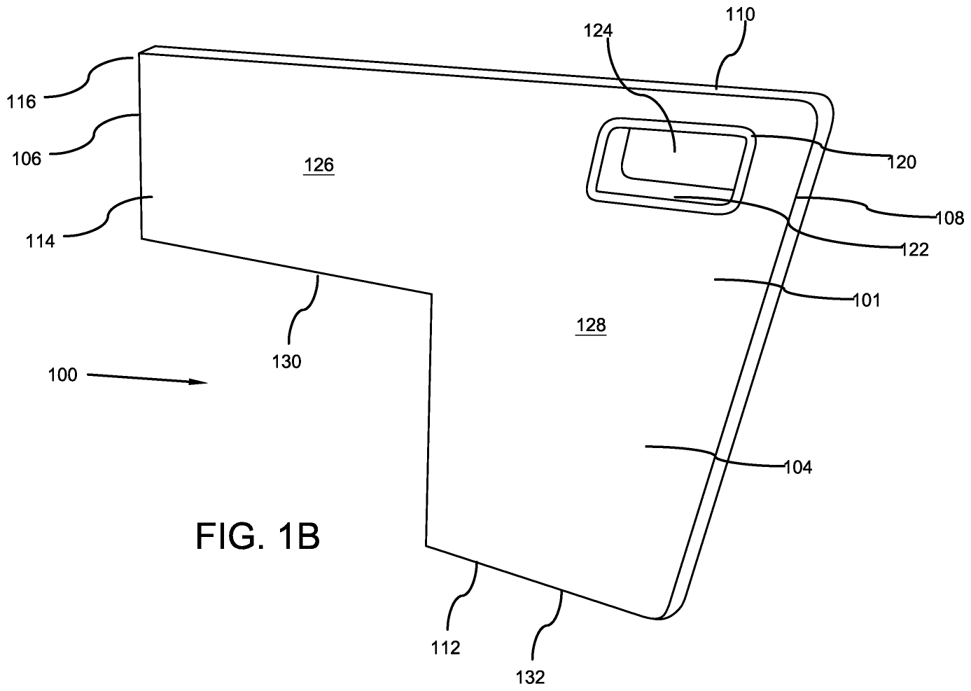

Referring initially to the drawings, FIGS. 1A and 1B illustrate a front perspective view and a rear perspective view of the golf cart metal/structural half or partial door of the present invention in accordance with the disclosed architecture. The golf cart metal/structural half or partial door 100 of the present invention is designed to attach on each side of an existing golf cart or during manufacturing of the golf cart to improve safety of passengers and stored items. The metal/structural half or partial door 100 is specifically designed to enable flow of air through the golf cart while preventing individuals, pets, and objects from falling out of the golf cart.

The metal/structural half or partial door 100 includes a planar member 101 having a front surface 102 and an opposite rear surface 104. The metal/structural half or partial door 100 further has a bolted or hinged end 106 and a latched end 108. A top end 110 and a bottom end 112 extends between the bolted end 106 and the latched end 108. The bolted end 106 includes a plurality of apertures 114 along the length 116 thereof, the plurality of apertures 114 are aligned with the hinged apertures on the golf cart frame for bolting the door 100 to the golf cart frame using hinges.

The front surface 102 includes a handle 118 which is held and pulled by a user for swinging the door 100 outwardly from the golf cart as illustrated and described later in the disclosure. The handle 118 is coupled to a latch system 120 disposed on the rear surface 104 of the door 100. The latch system 120 includes a latch 122 and a pull tab 124. The pull tab 124 is adapted to be pulled by a user to open the door and release the pull tab 124 to latch the door 100 to the golf cart frame.

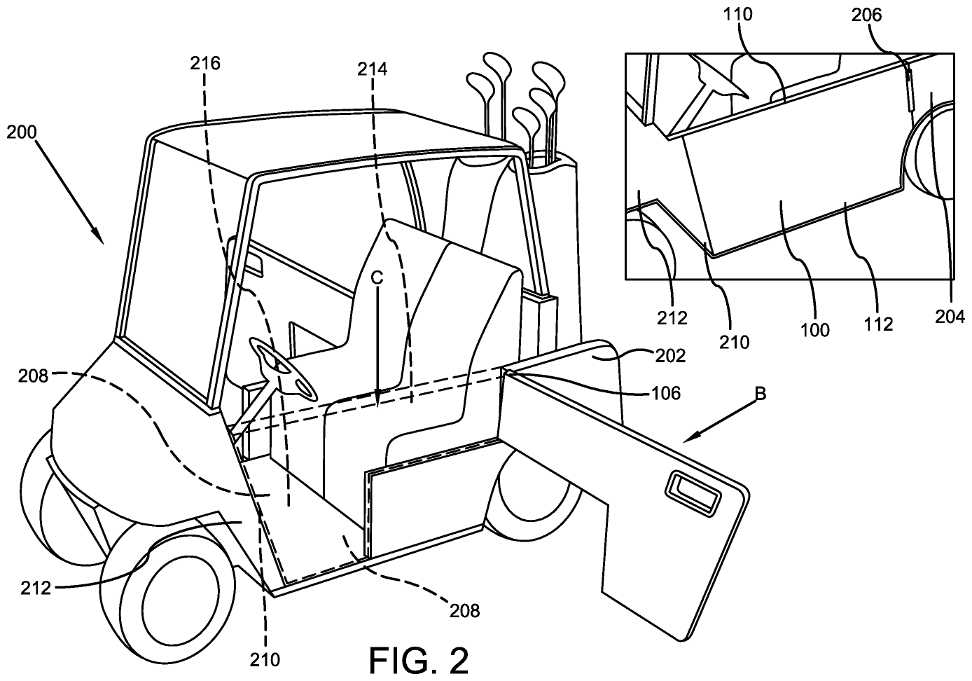

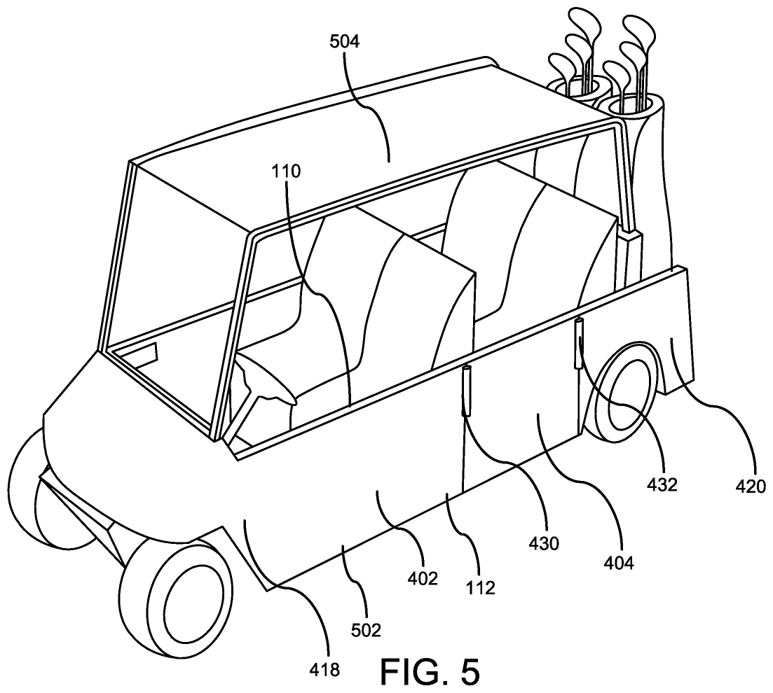

The design and size of the metal/structural half or partial door 100 can be based on the design and shape of the golf cart or any other similar vehicle. One advantage of the golf cart half or partial door 100 is that the height (Arrow A) extending between the top end (edge) 110 and the bottom end (edge) 112 is up to about 60% of the height of a golf cart from the base 502 to the top 504 as described in FIGS. 2 and 5. In one embodiment, the door 100 has a height of about 20% to 40% of the height of the golf cart for providing adequate air flow and protection of the passengers from falling out of the vehicle.

The door 100 has a cart seat protection portion 126 and a passenger leg room area protection portion 128. The portions 126, 128 are contiguous and form a one-piece structure of the metal/structural half or partial door 100. The cart seat protection portion 126 is designed to provide side support (i.e., a side barrier) to passengers sitting on seats of vehicles like golf carts and the passenger leg room area protection portion 128 provides support structure (i.e., lower cart barrier) to the passageway or leg room area of the golf cart.

The top edge 110 is generally linear and elongated and the bottom edge 112 can comprise a cart seat protection portion bottom edge 130 and a passenger leg room area protection portion bottom edge 132. The door 100 is adapted to swing outwardly from a golf cart on which the door 100 is attached. The swing or rotation is performed along the bolted end 106 and the latched end 108 is adapted to freely swing and rotate.

FIG. 2 illustrates a perspective view of the golf cart metal/structural half or partial door of the present invention equipped on a golf cart in accordance with one embodiment of the present invention. The door 100 can be attached to a golf cart 200 as an aftermarket product or can be integrated during manufacturing of the golf cart 200. The bolted end 106 is fixed to the golf cart frame 202 for a secure attachment of the door 100. In the present embodiment, the bolted end 106 is fixed to the rear fender edge 204 of the frame 202 using at least one hinge 206. The door 100 is adapted to rotate or swing along the bolted end 106 and conform to the shape and design to cover a side 208 of the golf cart 200.

The metal/structural half or partial door 100 is capable of transitioning from an open position (Arrow B) to a closed position (Arrow C). In the open position, the metal/structural half or partial door 100 is swung and positioned outwardly away from the golf cart 200 and provides access to the golf cart 100 by not covering or protecting the side 208. In the closed position, the metal/structural half or partial door 100 aligns with the side 208 and the latched end 108 adheres to the front fender edge 210 to form a contiguous structure of the front fender 212 and the metal/structural half or partial door 100.

In the closed position, the cart seat protection portion 126 protects and covers the seats 214 from the side 208 and the passenger leg room area protection portion 128 covers the legroom area 216 and thereby prevents the passengers and other items from falling out of the golf cart. In the closed position, the latch system 120 latches the door 100 to the golf cart frame 202 to prevent any unintentional disengagement and swinging of the door 100 relative to the golf cart frame 202.

It should be noted that the door(s) 100 can be installed on both sides of the golf cart 100 to protect the passengers and items from falling out. Further, the door 100 is directly attached to the frame 202 using the hinges and swings outward for easy accessibility to the interior of the golf cart 200. In the present embodiment, the golf cart 200 is a two-seat golf cart or any other similar vehicle and can have integrated doors 100 on both sides.

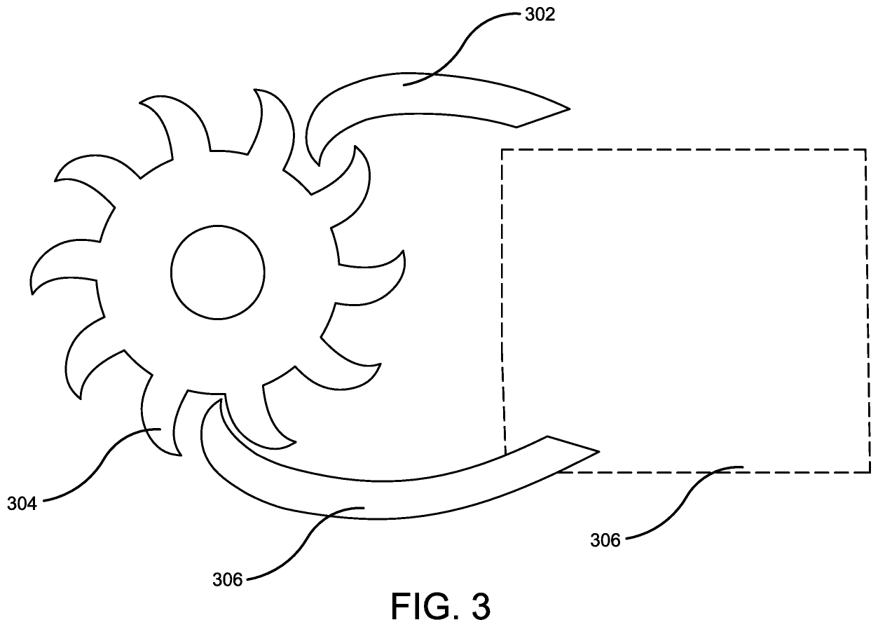

FIG. 3 illustrates an enlarged view of the latch system used for latching the metal/structural half or partial door to the golf cart frame in accordance with one embodiment of the present invention. The latch system 120 includes a pawl 302 connected to a ratchet 304. The ratchet 304 is operatively connected to a striker 306 which is extended when the pull tab 124 is released. The striker 306 is inserted into a striker plate 308 which is fastened to the front fender 212 to latch the door 100 when the pull tab 124 is pulled by a user. Upon pulling the pull tab 124, the pawl 302 rotates the ratchet 304 in one direction and rotates the ratchet 304 in the opposite direction on releasing the pull tab 124.

For latching the door 100, the door 100 swings towards the golf cart 200 to engage the striker 306 and the striker plate 308. The pull tab 124 or the handle 118 is pulled to disengage the striker 306 and the striker plate 308 to transition the door 100 into the open position.

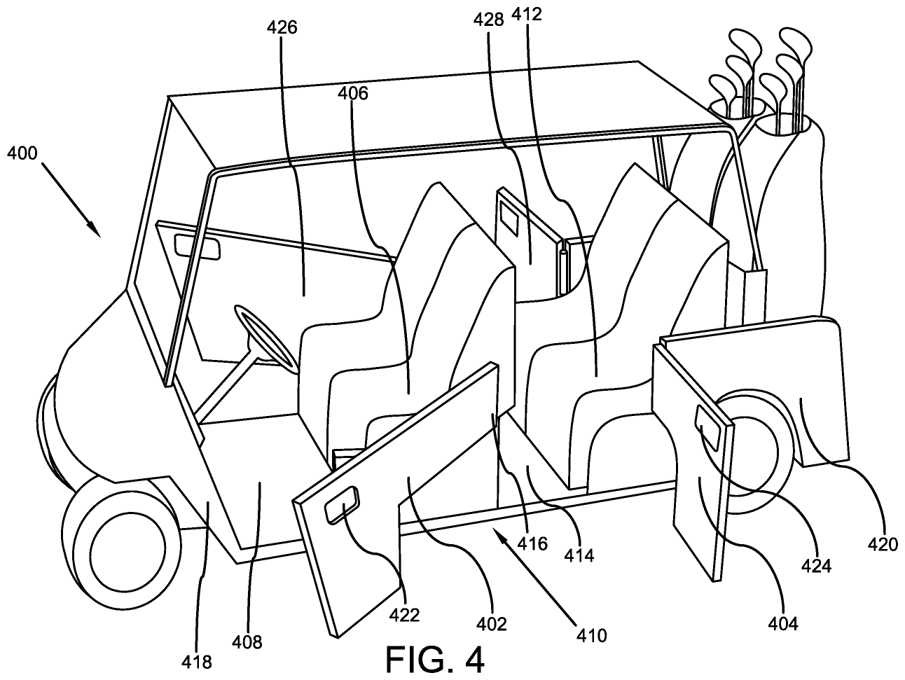

FIG. 4 illustrates a perspective view of a four-seat golf cart equipped with metal/structural half or partial doors of the present invention in accordance with one embodiment of the present invention. In the present invention, the four-seat golf cart 400 has a front left metal/structural half or partial door 402 and a rear left metal/structural half or partial door 404. The front left metal/structural half or partial door 402 is adapted to cover the front seats 406 and the front legroom area 408 from the left side 410 and the rear left metal/structural half or partial door 404 is adapted to cover the rear seats 412 and the rear legroom area 414 from the left side 410. The front left metal/structural half or partial door 402 is hinged to front seat left frame 416 and is latched to the front fender 418. The rear left metal/structural half or partial door 404 is hinged to the rear fender 420 using hinge 430 and becomes coplanar and contiguous when closed along with the front left metal/structural half or partial door 402 that is hinged using hinge 432 as illustrated in FIG. 5. The front left metal/structural half or partial door 402 has a corresponding latch 422 and the rear left metal/structural half or partial door 404 has the corresponding latch 424 thereof. The latches 422, 424 help users operate and use the doors 402, 404 separately and independently for accessing the golf cart 400.

The doors 402, 404 can be retrofitted or can also be integrated to the golf cart 400 during the manufacturing thereof. The doors of different embodiments of the present invention, can be made of lightweight and corrosion-resistant metal or structural polymers. Further, the metal/structural doors can be painted to match the frame of different golf carts. The design and shape of the doors can be customized to conform to the design of the golf carts. The opposite side of the golf cart door 400 has the corresponding set of the doors 426, 428.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “golf cart metal/structural half or partial door”, “metal/structural half or partial door”, “door”, and “golf cart half or partial door”, are interchangeable and refer to the golf cart metal/structural half or partial door 100 of the present invention.

Notwithstanding the forgoing, the golf cart metal/structural half or partial door 100 of the present invention can be of any suitable size and configuration as is known in the art without affecting the overall concept of the invention, provided that it accomplishes the above stated objectives. One of ordinary skill in the art will appreciate that the golf cart metal/structural half or partial door 100 as shown in the FIGS. are for illustrative purposes only, and that many other sizes and shapes of the golf cart metal/structural half or partial door 100 are well within the scope of the present disclosure. Although the dimensions of the golf cart metal/structural half or partial door 100 are important design parameters for user convenience, the golf cart metal/structural half or partial door 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A structural partial door for a golf cart comprising:
a structural partial door; and
a planar member;
wherein said planar member having a front surface and a rear surface including a hinged end and a latched end;
wherein said planar member having a top edge and a bottom edge extending between said hinged end and said latched end;
wherein said hinged end having a first plurality of apertures along a length of said hinged end for aligning with a second plurality of apertures on a golf cart frame for securing said structural partial door to the golf cart frame;
wherein said front surface having a handle;
wherein said rear surface having a latch;
wherein said handle coupled to said latch for actuating said latch and selectively opening said structural partial door; and
further wherein said structural partial door having a height up to 60% of a height of a golf cart from a base of the golf cart to a top of the golf cart.

2. The structural partial door for a golf cart of claim 1, wherein said structural partial door having a height of 20% to 40% of the height of the golf cart.

3. The structural partial door for a golf cart of claim 2, wherein said structural partial door having a cart seat protection portion and a leg room area protection portion.

4. The structural partial door for a golf cart of claim 3, wherein said cart seat protection portion and said leg room area protection portion are contiguous and form a one-piece structure of said structural partial door.

5. The structural partial door for a golf cart of claim 4, wherein said structural partial door having a material selected from the group consisting of a metal and a polymer.

6. The structural partial door for a golf cart of claim 4, wherein said cart seat protection portion provides a side barrier to passengers sitting on a seat of the golf cart.

7. The structural partial door for a golf cart of claim 6, wherein said leg room area protection portion provides a lower cart barrier to the passageway of the golf cart.

8. The structural partial door for a golf cart of claim 7, wherein said cart seat protection portion and said leg room area protection portion are contiguous and form a one-piece structure of said structural partial door.

9. A structural partial door for a golf cart comprising:
a structural partial door; and
a planar member;
wherein said planar member having a front surface and a rear surface including a hinged end and a latched end;
wherein said planar member having a top edge and a bottom edge extending between said hinged end and said latched end;
wherein said hinged end having a first plurality of apertures along a length of said hinged end for aligning with a second plurality of apertures on a golf cart frame for securing said structural partial door to the golf cart frame;
wherein said front surface having a handle;
wherein said rear surface having a latch;
wherein said handle coupled to said latch for actuating said latch and selectively opening said structural partial door;
wherein said structural partial door having a height up to 60% of a height of a golf cart from a base of the golf cart to a top of the golf cart;
wherein said structural partial door having a cart seat protection portion and a leg room area protection portion;
wherein said cart seat protection portion and said leg room area protection portion are contiguous and form a one-piece structure of said structural partial door;
wherein said top edge is linear; and
further wherein said bottom edge is non-linear extending along said cart seat protection portion and said leg room area protection portion.

10. The structural partial door for a golf cart of claim 9, wherein said hinged end is fixed to a rear fender edge of a frame of the golf cart.

11. The structural partial door for a golf cart of claim 10, wherein said structural partial door having a height of 20% to 40% of the height of the golf cart.

12. The structural partial door for a golf cart of claim 11, wherein said structural partial door having a cart seat protection portion and a leg room area protection portion.

13. The structural partial door for a golf cart of claim 12, wherein said cart seat protection portion and said leg room area protection portion are contiguous and form a one-piece structure of said structural partial door.

14. The structural partial door for a golf cart of claim 13, wherein said structural partial door having a material selected from the group consisting of a metal and a polymer.

15. The structural partial door for a golf cart of claim 13, wherein said cart seat protection portion provides a side barrier to passengers sitting on a seat of the golf cart.

16. The structural partial door for a golf cart of claim 15, wherein said leg room area protection portion provides a lower cart barrier to the passageway of the golf cart.

17. The structural partial door for a golf cart of claim 16, wherein said cart seat protection portion and said leg room area protection portion are contiguous and form a one-piece structure of said structural partial door.

18. A structural partial door for a golf cart comprising:
a structural partial door;
a planar member;
wherein said planar member having a front surface and a rear surface including a hinged end and a latched end;
wherein said planar member having a top edge and a bottom edge extending between said hinged end and said latched end;
wherein said hinged end having a first plurality of apertures along a length of said hinged end for aligning with a second plurality of apertures on a golf cart frame for securing said structural partial door to the golf cart frame;
wherein said front surface having a handle;
wherein said rear surface having a latch;
wherein said handle coupled to said latch for actuating said latch and selectively opening said structural partial door;
wherein said structural partial door having a height of 20% to 40% of the height of the golf cart from a base of the golf cart to a top of the golf cart;
wherein said structural partial door having a cart seat protection portion and a leg room area protection portion;
wherein said cart seat protection portion and said leg room area protection portion are contiguous and form a one-piece structure of said structural partial door;
wherein said top edge is linear;
wherein said bottom edge is non-linear extending along said cart seat protection portion and said leg room area protection portion;
wherein said hinged end is fixed to a rear fender edge of a frame of the golf cart; and
further wherein said latched end in a closed position is aligned with a front fender edge of the frame of the golf cart.

19. The structural partial door for a golf cart of claim 18, wherein said structural partial door having a cart seat protection portion and a leg room area protection portion, and further wherein said cart seat protection portion and said leg room area protection portion are contiguous and form a one-piece structure of said structural partial door.

20. The structural partial door for a golf cart of claim 19, wherein said cart seat protection portion provides a side barrier to passengers sitting on a seat of the golf cart, and further wherein said leg room area protection portion provides a lower cart barrier to the passageway of the golf cart.
